(19) United States
(12) Patent Application Publication
(10) Pub. No.: US 2002/0009996 A1
(43) Pub. Date: Jan. 24, 2002

(54) Initial menu registration method and cellular information communication terminal

(75) Inventors: Yoshitaka Okada, Tokyo (JP); Takashi Yamazaki, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/905,967

(22) Filed: Jul. 17, 2001

(30) Foreign Application Priority Data
Jul. 19, 2000 (JP) 219202/2000

(51) Int. Cl. H04Q 7/20

(52) U.S. Cl. 455/435; 455/432

(57) ABSTRACT

A telephone dealer connects the cellular phone with a personal computer then starts an initial menu writing software on the personal computer. First, a command to display an initial menu of the cellular phone is outputted, and an information menu image is displayed on a display screen of the personal computer. The respective information on the menu image comprise characters linked to files in service centers where these information are written. The telephone dealer explains the respective information of the menu and the contents of the detailed information by using a pamphlet (paper) or a guidance image on the personal computer. The user selects information to be registered in the initial menu of the cellular phone. The telephone dealer inputs the information selected by the user into the personal computer, then the personal computer stores the information . When input of all the desired information has been completed and writing designation is made, an information writing command is outputted from the personal computer to write all the stored information with a display order to the cellular phone.

### BACKGROUND OF THE INVENTION

1. Field of the Invention

The present invention relates to initial menu registration at a cellular information communication terminal, and more particularly, to initial menu registration for a user to obtain text information, image and music at a cellular information terminal having a communication function. The present application is based on Japanese Patent Application No. 219202/2000, which is incorporated herein by reference.

2. Background

Today's explosive use of cellular phones is dramatically changing the initial purpose of cellular phones of talking” into cellular type information communication terminals with functions to “using” information. That is, a user can access official content provided by cellular phone companies (carriers) from the cellular phone, to search the latest information or news or to enjoy music or games. Further, the user connects the cellular phone with the Internet to access content throughout the world.

Because use of such information services depends on the frequency of use of cellular phones, the carriers prepare information that is needed and will be very useful to the public. An initial menu of the information has, e.g., news & weather information, daily convenience information, entertainment information, fortune telling information and the like. However, a particular user may require customized information such as stock information of specific companies, detailed information of Yomiuri Giants, conditions specific golf courses and the weather forecast of specific area. This detailed information is contained in an information selection menu provided by the carrier and the like, however, generally, the selection menu exists in lower levels of the hierarchy from the initial menu.

Accordingly, the user conventionally searches for desired specific information by depressing a button of the cellular phone several times or inputting data with buttons of the cellular phone in some cases to find the desired information. For example, to obtain tomorrow's weather forecast of Kawasaki City of Kanagawa Prefecture, first, the phone is set to receive a text information service and the initial menu (main menu) is displayed. Then the item news & weather is selected from the displayed image. Next, a menu containing the items news headline, stock price delay information, sky spot information, today & tomorrow's weather, weekly weather and the like, is displayed. If today & tomorrow's weather is selected from the display image, the name of the prefecture or city code is required to be entered. When the input is made, the desired tomorrow's weather forecast of Kawasaki City of Kanagawa Prefecture is obtained.

Note that to obtain detailed information unique to the user, in addition to selecting information prepared by the carrier from the menu as described above, another known method is inputting a keyword or URL (Uniform Resource Locator) to specify the information with the buttons of the cellular phone to obtain the information via the Internet.

However, because a cellular phone has a compact size, it sacrifices operability for convenience of portability. The number of buttons is small and the display screen is small. Accordingly, in case of the above-described conventional cellular phone, to access desired information, the user depresses the buttons to make selections several times while checking each selection result, and access to the desired information from the initial menu or by Internet access is not always readily made. This can be stressful to the user.

Another problem is that to move from a menu image to a lower-level menu image, it is necessary for the cellular phone to access a service center to obtain menu image information in accordance with the user's selection. Since this takes a considerable amount of time, waiting for the acquisition of the information can also be stressful to the user. This problem also occurs in case of the Internet access.

Further, a barrier to information services exists subliminally in the user, and further saps users' appetite for buying the cellular phones. A third problem is that the information services utilized by the users are limited to sites with high public usefulness. As a result, the information services do not respond to users' needs to easily obtain information specialized to their hobby, entertainment and business. Therefore, these other sites lose potential customers.

The present invention has been made in consideration of these problems, and has as its first object to provide an initial menu registration method and a cellular information communication terminal enabling a user to obtain desired information easily and without stress.

Further, a second object of the present invention is to provide an initial menu registration method and a cellular information communication terminal increases utilization of other business sites.

### SUMMARY OF THE INVENTION

A first aspect of the present invention provides an initial menu registration method for registering information desired by a user in an initial menu for information acquisition displayed on a display screen of a cellular information communication terminal, including: signing a contract to provide information between a cellular information communication terminal dealer and an information provider site; generating an information menu with a list of information provided from the contracted site, by the cellular information communication terminal dealer; presenting the information menu when the cellular information communication terminal dealer sells the cellular information communication terminal to the user; and registering the desired information selected from the information menu by the user purchased said cellular information communication terminal, into the cellular information communication terminal, by the cellular information communication terminal dealer.

More specifically, the registration is made by connecting a writing terminal to the cellular information communication terminal and writing an address on the side of the information provider site of the information by a CPU of the cellular information communication terminal into an internal memory, by a command from the writing terminal.

A second aspect of the present invention provides an initial menu registration method for registering information desired by a user in an initial menu for information acquisition displayed on a display screen of a cellular information communication terminal, including: finding an information provider site that seems to be popular among users or needed by the users, upon development of said cellular information communication terminal, and signing a contract with the site, by a cellular information communication terminal maker; and preinstalling information provided by the contracted site in the initial menu for information acquisition displayed on the display screen of the cellular information communication terminal.

A third aspect of the present invention provides an initial menu registration method for registering information desired by a user in an initial menu for information acquisition displayed on a display screen of a cellular information communication terminal, including: signing a contract to provide information between a cellular information communication terminal dealer and an information provider site; generating an information menu with a list of information provided from the contracted site, by said cellular information communication terminal dealer; presenting the information menu when the cellular information communication terminal dealer sells the cellular information communication terminal to the user; transmitting a menu having desired information to the cellular information communication terminal by the information provider, in response to the user's request through the Internet; and registering the desired information in the initial menu for information acquisition displayed on the display screen of the cellular information communication terminal, in response to the user's operation.

In the cellular information communication terminal according to the present invention, the information desired by the user is registered in the initial menu for information acquisition of the cellular information communication terminal by the above-described respective initial menu registration methods.

### BRIEF DESCRIPTION OF THE DRAWINGS

The above and other objects, advantages and features of the present invention will be more apparent from the following description taken in conjunction with the accompanying drawings, in which:

FIG. 1 is a diagram showing the concept of the present invention.

FIG. 2 is a diagram showing an example of device construction for execution of the first initial menu registration method according to the present invention.

FIG. 3 is a plan diagram showing the 16-core connector of the cellular phone.

FIG. 4 is a flowchart of the initial menu writing software that performs the first initial menu registration method according to the present invention.

FIG. 5 is a diagram showing transition of display images during execution of the first initial menu registration method according to the present invention.

FIG. 6 a diagram showing an example of the menu image displayed on the personal computer.

### BRIEF DESCRIPTION OF THE PREFERRED EMBODIMENTS

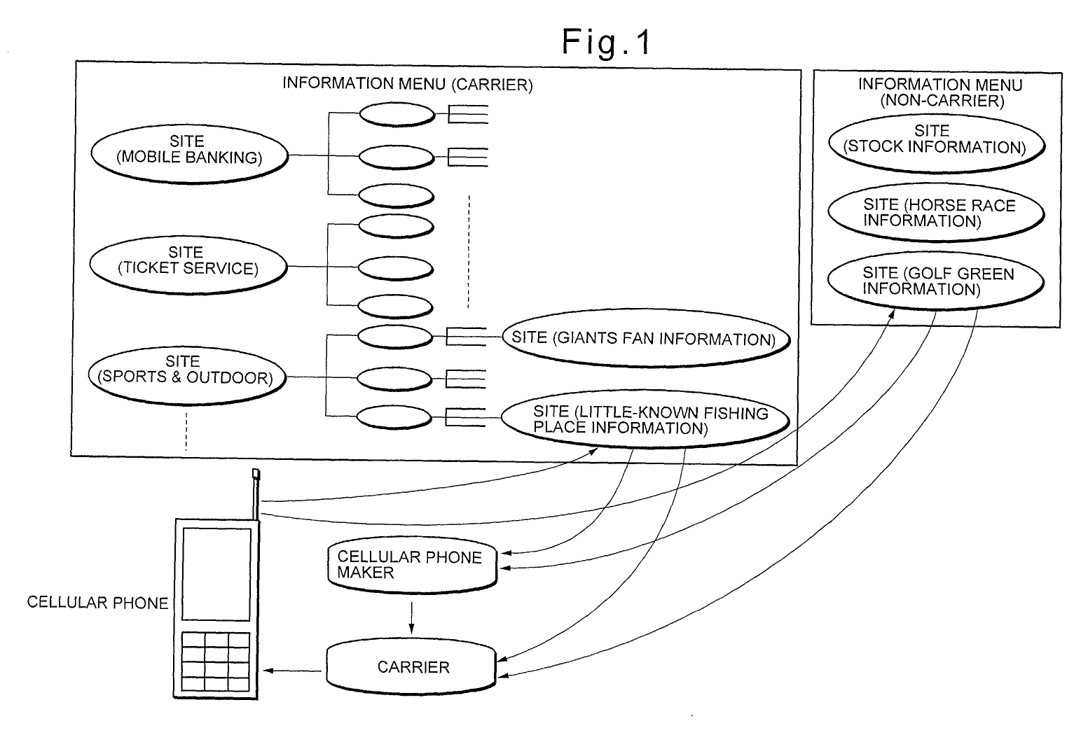

First, the concept of the present invention will be specifically described with reference to FIG. 1. The present invention enables one-operation access to specialized hobby and entertainment information at a lower level of hierarchy of information menu provided by carriers or information accessible via the Internet providers by information providers other than the carriers of a cellular phone. FIG. 1 shows, as an example of an information menu provided by the carriers, mobile banking, ticket service and sports & outdoor information having high public usefulness, and Giants fan information and little-known fishing place information as specialized hobby and entertainment information. Further, the figure shows, as information provided by information providers other than the carriers, stock information, horse race information and golf course information.

A cellular phone maker registers contracted sites, e.g., little-known fishing place information and golf course information, in an initial menu of the cellular phone. At this time, the cellular phone maker is paid with registration fees from the sites, and the maker sells the cellular phone to the carriers at a price discounted for the registration fees. Further, the site registration may be made by the carriers to register sites desired by users in the respective initial menus. In this case, the carriers can sell the cellular phone to the users at a price discounted by the site registration fee.

From the cellular phone where the above site registration has been made, the little-known fishing spot information and golf course information, which have conventionally existed in lower levels of the information menu of the cellular phone, and the golf course information, which has been accessed via the Internet, can be accessed at once.

Next, a first example of the initial menu registration method according to the present invention will be described. A cellular phone dealer signs contracts with sites of information providers for providing information, and generates an information menu with listed information provided by the contracted sites. Then the cellular phone dealer presents the information menu when the cellular phone is sold to a user. When the user who purchased the cellular phone selects desired information to be added to an initial menu for information acquisition (hereinbelow,“initial menu”) from the information menu, the cellular phone dealer registers the information in the initial menu of the cellular phone. Information to be registered includes information which can be browsed from any personal computer by inputting an URL as well as information owned by the carriers which can be browsed only by the carrier's terminal (personal computer).

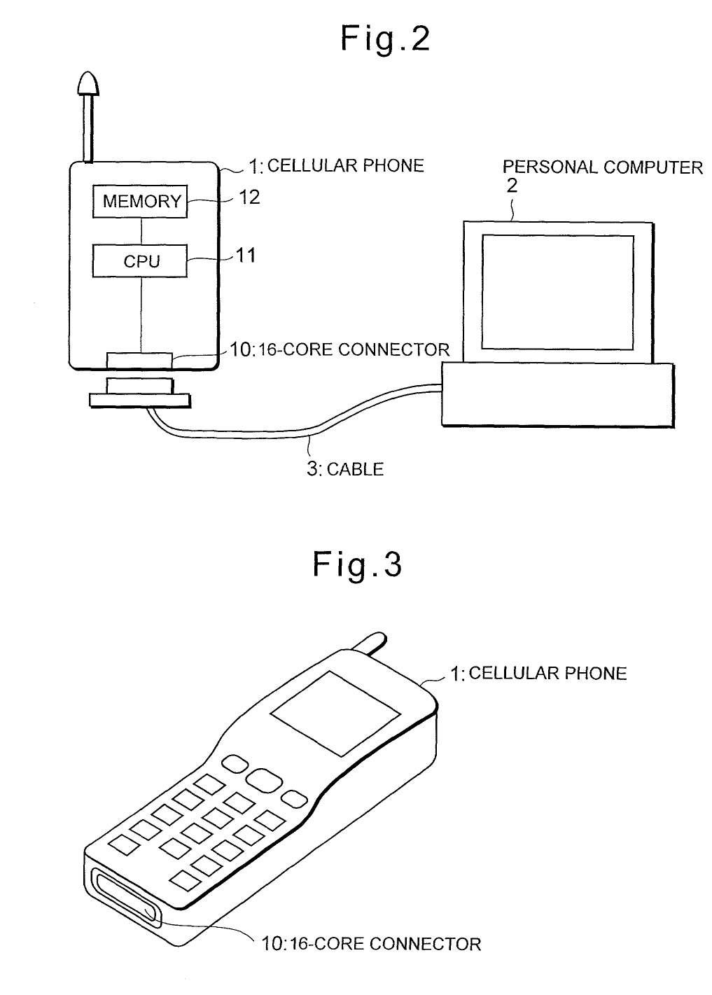

FIG. 2 shows an example of the construction of a device for executing of the first embodiment of the initial menu registration method according to the present invention. The initial menu registration in the device in FIG. 2 is made by the carrier. A user who wishes vs one-operation access to a menu including desired information (hereinbelow “desired menu”) brings a cellular phone 1 to the carrier's telephone dealer to have a desired menu registered as the initial menu. At the telephone dealer, as shown in FIG. 3, a cover on a front side surface of the cellular phone 1 is opened, and a cable 3 from a personal computer 2 is connected to a 16-core connector 10 provided under the cover. A connector to be connected to the 16-core connector 10 is provided at the end of the cable 3. The 16-core connector 10 is connected to a CPU 11 of the cellular phone 1, and information inputted from the personal computer 2 is written by the CPU 11 via the cable 3 and the 16-core connector 10 into a memory 12. The memory 12 holds information on the initial menu to be displayed on a display screen of the cellular phone 1 to receive information service.

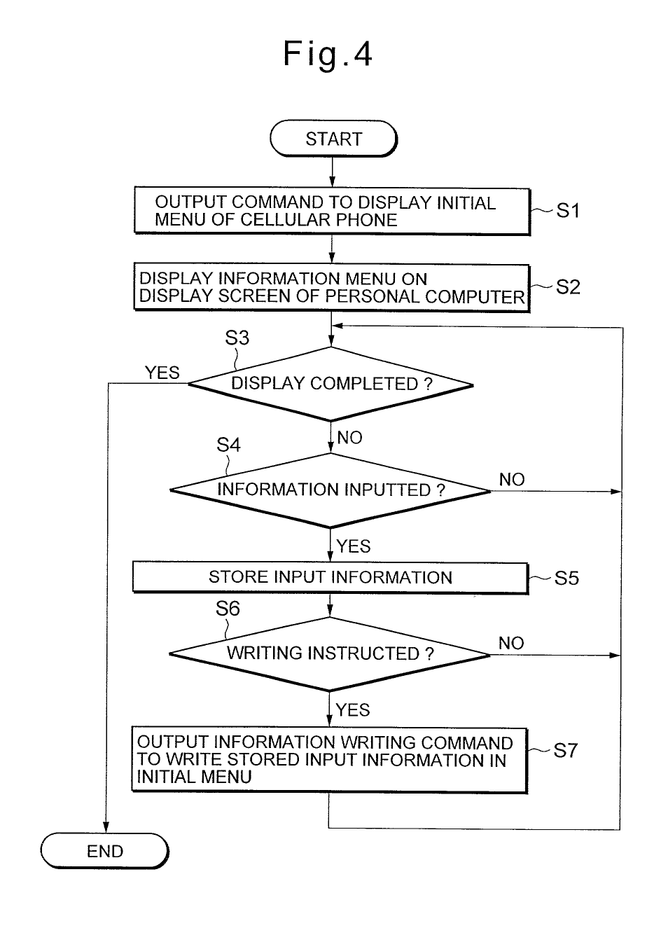

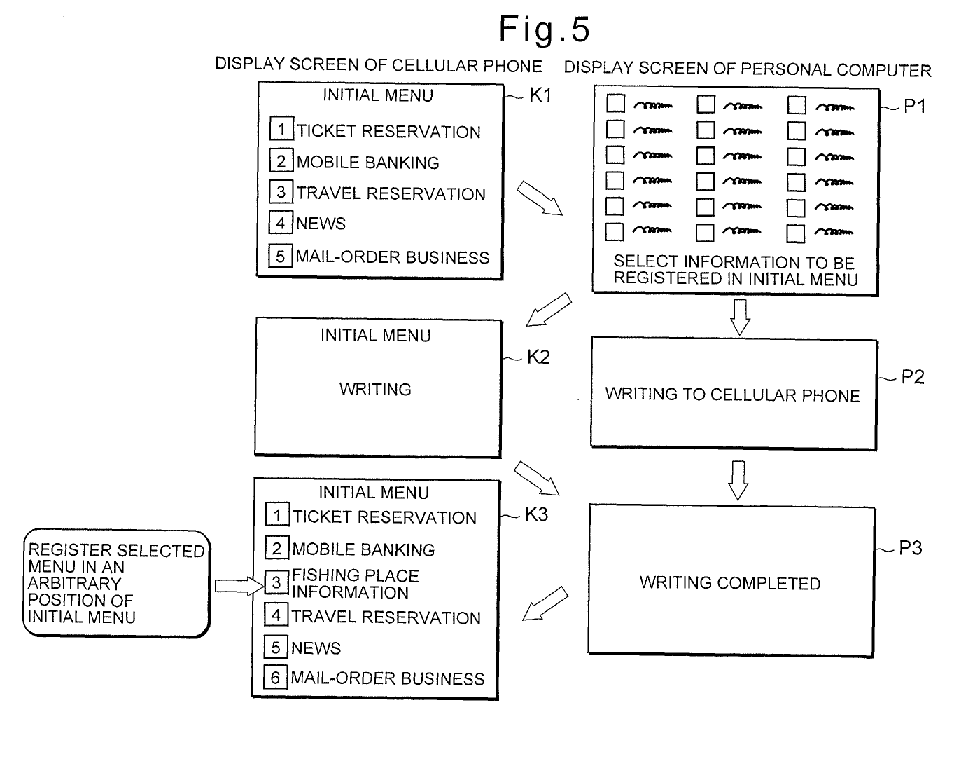

As shown in FIG. 2, the telephone dealer connects the cellular phone 1 with the personal computer 2 via the cable 3, and starts initial menu writing software on the personal computer 2. FIG. 4 shows a flowchart of the initial menu writing software. FIG. 5 shows the transition of the display screen of the cellular phone 1 and that of the personal computer 2 in that case.

The initial menu writing software first outputs a command to display the initial menu of the cellular phone 1 (step S1 in FIG. 4). As a result, the CPU 11 reads information of the initial menu of the cellular phone 1 stored in the memory 12, and displays an initial menu image K1 as shown in FIG. 5. In the initial menu image K1, information with high public usefulness, such as information on ticket reservations, mobile banking, travel reservations, news, and mail-order businesses are displayed. However, information on fishing as the user's hobby, especially little-known fishing place information, is not included in this menu. The user that wants to display the little-known fishing place information at once can do so by adding the information to the initial menu.

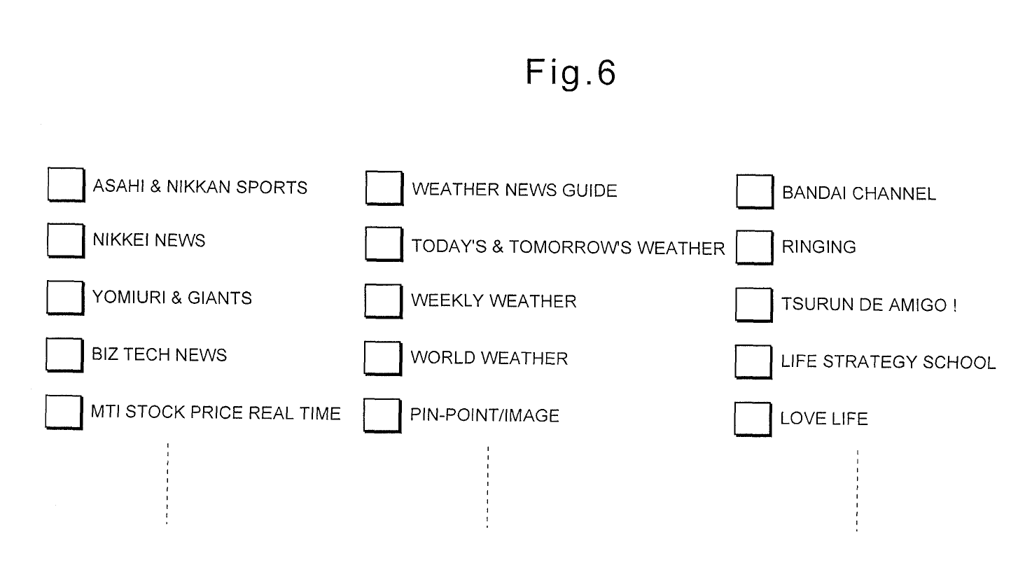

On the other hand, a menu image covering a large number of information like an image P1 in FIG. 5 is displayed on the display screen of the personal computer 2 (step S2 in FIG. 4). FIG. 6 shows an example of this menu image. The respective information on the menu image comprise characters linked to files in service centers, as in the case of the respective information of the initial menu in the cellular phone 1. More particularly, the characters indicate addresses of files in the service centers.

The telephone dealer explains or gives a guidance to the user about the contents of the respective information and their detailed information by using a pamphlet (paper) or the guidance image P1 of the personal computer 2. The user selects the little-known fishing place information to be registered in the initial menu image of the cellular phone 1 from the menu image P1, and informs the telephone dealer of it. Further, the user may select little-known fishing place information which is not registered in the menu image P1 from a pamphlet or further may select little-known fishing place information which is not published in the pamphlet. Note that in this case, it is necessary for the telephone dealer to determine whether or not the information site deserves a contract (determination as to whether or not there is inappropriate content). Further, a display order in the initial menu can be selected. The telephone dealer inputs the little-known fishing place information selected by the user into the personal computer 2 (step S4 in FIG. 4), then the personal computer 2 stores it (step S5 in FIG. 4).

The steps S4 and S5 are repeated until a writing selection is made (step S6 in FIG. 4) or a termination selection is made (step S3 in FIG. 4). This enables the user to set a plurality of information in the initial menu for one-operation access. When the input of all the desired information has been completed and a writing selection is made (step S6 in FIG. 4), the personal computer 2 outputs an information writing command to write all the stored information with the display order to the cellular phone 1 (step S7 in FIG. 4).

The information writing command with the above selected little-known fishing place information is transmitted via the cable 3 and the 16-core connector 1 0 to the CPU 11. The CPU 11 writes the little-known fishing information into the memory 12. In this case, if the rank of the little-known fishing place information in the display order is selected, the order of the respective information constructing the initial menu is arranged and the information is written. Further, if a plurality of information have been selected to be written, the writing to the memory 12 is repeated for the number of information.

During this operation, a message “writing” is displayed in an image K2 (FIG. 5) of the cellular phone 1, while a message “writing to cellular phone” is displayed in an image P2 (FIG. 5) of the personal computer 2. In the cellular phone 1, when the writing of the little-known fishing place information inputted into the personal computer 2 has been completed, a message “writing completed” is displayed in an image P3 (FIG. 5) of the personal computer 2, while the little-known fishing place information desired by the user is displayed following the ticket reservation and mobile banking information in an image K3 (FIG. 5) of the cellular phone 1, since the rank of the little-known fishing place information was selected to be third in the display order. If there is no particular designation, the information is displayed at the last on the list. The telephone dealer terminates the initial menu writing software, turns the power off, then pulls the cable 3 from the 16-core connector 10 and closes the cover, and hands the cellular phone 1 to the user.

As a result of the above operation, when the user receives information service by using the cellular phone 1, the little-known fishing place information is added to data read from the memory 12 by a program to display the initial menu, and the data is displayed in the initial menu image K1 at once. Thus necessary information can be easily and quickly obtained.

In the present example, when the carrier sells a cellular phone to a user, the carrier introduces contracted sites and installs information desired by the user in the initial menu. The site providing the information pays a site registration fee to the carrier. Because the carrier can sell the cellular phone to the user at a price discounted by the site registration fee, the carrier can promote sales of the cellular phone. Further, when the user knows that this convenient service is available, the user feels free to utilize the information services. Thus convenience to users can be improved, and the income of the sites increases.

In the above example, the carrier adds the information desired by the user to the initial menu. However, a second working example of the cellular phone maker's adding the information desired by the user to the initial menu is described below. In this case, the cellular information communication terminal maker signs contracts with sites of information providers. Information to be registered may mainly be information which can be browsed from any personal computer by input of an URL. Upon development of cellular phone, the maker finds sites of information providers which seem to be popular among users or seem to be needed by the users, then signs contracts with the sites, and preinstalls the information in the initial menu. More particularly, URLs of the information are written into the memory 12 in advance.

As an example of this case, it may be arranged such that information on a professional baseball team, Hanshin Tigers (records of games, schedule, players information and the like) is registered in the initial menu of cellular phone, and the cellular phone colored in tiger-like stripes (black and yellow bands) is sold as “Hanshin Fan Cellular Phone”. The unique nature of the Hanshin Tigers having great fans can lead to a business opportunity.

According to the second example, although there may be a difference between user's taste and the cellular phone maker's prediction, there is an advantage in that the user does not have to go to the carrier to add desired information to the initial menu.

In this example, the information provider pays the site registration fee to the cellular phone maker. As a result, when the cellular phone maker grants authorization for sales of the cellular phone to the carrier, the maker can sell the cellular phone at a price discounted by the site registration fee. The other advantages are the same as shown in the first working example.

Next, a third example, a method for adding desired information to the initial menu by the user will be described below. In this working example, the cellular phone dealer signs contracts with sites of information providers, and generates an information menu with listed information provided by the contracted sites. When the cellular phone dealer sells the cellular phone to the user, the dealer presents the information menu. This process is the same as that in the first working example.

When the user who purchased the cellular phone selects desired information to be added to the initial menu for information acquisition, the user accesses the Internet from the cellular phone to access an information provider which provides the desired information, to conduct registration formalities. Then the user has the provider transmit a menu including the desired information to the cellular phone. The desired information may exist in a lower level of the hierarchy of the menu, however, the user himself/herself operates the cellular phone (operates it by using buttons) and adds the information to the initial menu to the cellular phone. As a result, the user can quickly access the desired information from the initial menu.

According to this method, there is an advantage in that the user can freely perform registration or cancel registration at any time. The user pays a registration fee to the information provider, however, the information provider pays the fee to the carrier, and the carrier returns the profit to the user by reducing the basic fee or telephone-call charge of the cellular phone.

In all the above examples, it may be arranged such that when the user registers information in the initial menu, the predetermined display of the information can be changed to that more understandable. For example, “Entertainment” may be changed to “Music, Films, Sports etc.” understandable for even child users, or “Tenki” may be changed to “WEATHER” understandable by American users.

Further, in all the above examples, it may be arranged such that the user can obtain information registered in the initial menu by voice. For example, if the user produces a speech sound “news”, a “news” site is accessed, or if the user produces a speech sound “keiba”, a “horse race” site is accessed. This working example is significant in a case where the user cannot operate the cellular phone by pressing the buttons.

Further, in all the above examples, information registered in the initial menu is limited to information prepared by information providers, however, it may be arranged such that information to display the user's current position in form of map or address on the display screen of the cellular phone, by utilizing GPS (Global Positioning System), is added to the initial menu. The current position may be obtained from a base station with respect to the current position of the cellular phone.

Note that the above description has been made about a cellular phone, however, the present invention is not limited to the cellular phone but is applicable to any cellular information terminal as long as it has a communication function as in the case of the cellular phone.

The present invention achieves the first objective because the user can be released from stress due to operation of cellular information communication terminal and waiting time for information acquisition to obtain desired information since the user can select desired preferred information from the initial menu.

Further, the invention achieves the second objective because the information provider can increase potential business opportunities since the user can easily obtain desired preferred information.

The present invention is not limited to the above embodiments, and it is contemplated that numerous modifications may be made without departing from the spirit and scope of the invention. The method for registering an information in an initial menu, as described above with reference to the drawings, is a merely an exemplary embodiment of the invention, and the scope of the invention is not limited to these particular embodiments. Accordingly, other method may be used, without departing from the spirit and scope of the invention as defined in the following claims.

What is claimed is:

1. An initial menu registration method for registering information in an initial menu displayed on a display screen of a cellular information communication terminal, comprising:
making an information menu with a list of a plurality of information provided from an information provider site, by a cellular information communication terminal dealer;
presenting said information menu from said cellular information communication terminal dealer to a user; and
registering at least one said information, selected from said information menu by said user, into said cellular information communication terminal, by said cellular information communication terminal dealer, to form said initial menu comprising said at least one information.

2. The initial menu registration method as claimed in claim 1, wherein said information is an address indicating said information provider site.

3. The initial menu registration method as claimed in claim 2, wherein said registering further comprises:
connecting a writing terminal to said cellular information communication terminal;
supplying a command to a CPU of said cellular information communication terminal by said writing terminal; and
writing said address into an internal memory of said cellular information communication terminal by said CPU in response to said command.

4. The initial menu registration method as claimed in claim 1, wherein said initial menu comprises a plurality of sites, said sites including said plurality of information.

5. The initial menu registration method as claimed in claim 1, wherein said at least one information is renamed.

6. The initial menu registration method as claimed in claim 1, wherein said information in said initial menu is selected by voice.

7. The initial menu registration method as claimed in claim 1, wherein said cellular information communication terminal is a cellular phone.

8. An initial menu registration method for registering information in an initial menu displayed on a display screen of a cellular information communication terminal, comprising:
preparing an initial menu comprising first information at a higher level of a hierarchy by an information provider site;
selecting second information at a lower level of said hierarchy by a cellular information communication terminal dealer; and
installing said second information into said initial menu, wherein said first information comprises said second information.

9. The initial menu registration method as claimed in claim 8, wherein at least one said information is renamed.

10. The initial menu registration method as claimed in claim 8, wherein said information in said initial menu is selected by voice.

11. The initial menu registration method as claimed in claim 8, wherein said cellular information communication terminal is a cellular phone.

12. An initial menu registration method for registering information in an initial menu displayed on a display screen of a cellular information communication terminal, comprising:
making an information menu with a list of a plurality of information provided from an information provider site, by a cellular information communication terminal dealer;
presenting said information menu from said cellular information communication terminal dealer to an user;
sending at least one said information, selected from said information menu by said user, to said cellular information communication terminal, by said cellular information communication terminal dealer; and
registering said at least one information into said cellular information communication terminal by said user, to form said initial menu comprising said at least one information.

13. The initial menu registration method as claimed in claim 12, wherein said at least one information is renamed.

14. The initial menu registration method as claimed in claim 12, wherein said information in said initial menu is selected by voice.

15. The initial menu registration method as claimed in claim 12, wherein said cellular information communication terminal is a cellular phone.

16. A cellular information communication terminal, comprising:
an initial menu comprising first information at a higher level of a hierarchy by an information provider site and second information at a lower level of said hierarchy by an information provider site,
wherein said second information is selected by user.

17. The cellular information communication terminal as claimed in claim 16, wherein said initial menu for information acquisition is set by a dealer of said cellular information communication terminal.

18. The cellular information communication terminal as claimed in claim 16, wherein said initial menu for information acquisition is set by a carrier of said cellular information communication terminal.

19. The cellular information communication terminal as claimed in claim 16, wherein said initial menu for information acquisition is set by said user based on information presented by a dealer of said cellular information communication terminal

20. The cellular information communication terminal as claimed in claim 16, wherein said second information is renamed.

21. The cellular information communication terminal as claimed in claim 16, wherein said second information is selected by voice.

22. The cellular information communication terminal as claimed in claim 16, wherein said cellular information communication terminal is a cellular phone.
